(19) United States
(12) Patent Application Publication
(10) Pub. No.: US 2004/0089615 A1
(43) Pub. Date: May 13, 2004

(54) Evaporation control device for multiwell plates

(76) Inventors: Alan Weiss, Acton, MA (US); Stephane Jean Marie Olivier, Rosheim (FR); John B. Lynch, Billerica, MA (US); Kenneth G. DeSilets, Westford, MA (US)

Correspondence Address: MILLIPORE CORPORATION, 290 CONCORD ROAD, BILLERICA, MA, 01821, US

(21) Appl. No.: 10/659,550

(22) Filed: Sep. 9, 2003

Related U.S. Application Data
(60) Provisional application No. 60/425,649, filed on Nov. 12, 2002.

(51) Int. Cl. C02F 1/00

(52) U.S. Cl. 210/739

(57) ABSTRACT

An evaporation control device for a multiwell plate system that reduces the evaporation from the plate such as during centrifugation. Preferably it substantially conforms to the shape and size of the plate system. A first design is a sheet material interposed between the adjacent surface so f the plates. A second is a cover that has a skirt that extends downward from the top of the plate system to at least a point below the filter plate/collection plate interface. Preferably, the cover has a skirt that extends down to approximately the bottom of the collection plate and is formed of thin plastic that even more preferably has been vacuum formed into shape. A third embodiment is a combination of the two control devices.

The present invention relates to a device for limiting evaporation in multiwell plates. More particularly it relates to a device for controlling evaporation from such plates that are filtered using centrifugation as the driving force.

### BACKGROUND OF THE INVENTION

Multiwell plates have existed for many years and are used in laboratories worldwide to conduct various separation and filtration based experiments. These plates are typically formed of plastic and contain a series of wells that go from the top surface of the plate to a bottom surface of the plate. Some have the bottom surface sealed by membrane. Others have a bottom feature such as a membrane support formed of the plastic from the plate is made or formed of a separate piece of plastic that is glued, heat bonded or overmolded on to the top plate.

A common mechanism for inducing filtration in these plates is to place them on a centrifuge, typically a swinging bucket centrifuge and subject them to high gravitation and rotary forces caused by their rotation on the centrifuge which cause the liquid in the wells of the plate to pass through the membrane, any support structure and into a collection plate. Typical filtrations can last from 10 minutes to an hour or more and forces of 1000 to 3000× gravity.

In most applications, the retentate or material remaining on the plate is what is collected for further analysis and the filtrate is discarded. However, in many applications such as bound versus free drug assays, the filtrate is the material that must be collect for further analysis or use.

In those uses that collect the filtrate as the final product, the act of centrifugation causes a loss of liquid in the well due to evaporation created by the rotation of the plate on the centrifuge. Large volume applications are not suitable for other techniques. Likewise, viscous fluids such as serum-based assays are not capable of being filtered by systems other than centrifugation.

To overcome this loss, some equipment suppliers have developed cast plastic domes that are attached over the plate and seal against the centrifuge holder surface to prevent evaporation. FIG. 1 shows a dome 2 as attached to a holder 4 of a swinging bucket centrifuge (not shown). The dome 2 is held to the holder 4 by a series of metal clamps or bands 6. The plates (filter plate 8 on top of collection plate 10) are held within the dome 2 and the bottom edge 12 of the dome 2 is sealed against the surface 14 of the holder 4 by a gasket 16.

These domes limit the evaporation losses. However, they are large, expensive, difficult to assemble and handle and often require a modification to the centrifuge and its holder in order to accommodate the dome. Additionally, depending on the plates and dome chosen, different sized domes may be required to accommodate the different heights of the plates that can be combined in practice. Additionally, not all centrifuges can use or be fitted with a dome.

What is desired is a cover that provides the benefits of the dome without the cost, difficulty of attachment and the need to either modify existing centrifuges or buy new centrifuges to accommodate the domes. The present invention provides such a device.

### SUMMARY OF THE INVENTION

The present invention is an evaporation control device for a multiwell plate system that reduces evaporation during centrifugation.

In one embodiment, it is simply a sheet material that forms a gasket between the two plates to minimize the evaporation at the intersection of the two plates.

In another embodiment, it is the sheet material between the two plates and a cover over the top plate.

In a third embodiment, it is a cover which covers the top surface of the upper plate and has a skirt that extends downward from the top of the plate system to at least a point below the filter plate/collection plate interface. Preferably, it substantially conforms to the shape and size of the plate system. Preferably, it is formed of thin plastic that even more preferably has been vacuum formed into shape. In another preferred embodiment, the cover has a skirt that extends down to approximately the bottom of the collection plate.

### IN THE DRAWINGS

FIG. 1 shows a dome in cross-sectional view as is used in the prior art.

FIG. 2 shows a first embodiment of the present device in cross sectional view.

FIG. 2a shows a first embodiment of the present device in exploded assembly view.

FIG. 3 shows a second embodiment of the present device in cross sectional view.

FIG. 4 shows an embodiment of the present device in cross sectional view.

FIG. 5 shows another embodiment of the present device in cross sectional view.

FIG. 6 shows a further embodiment of the present device in cross sectional view.

FIGS. 7a and 7b show additional embodiments of the present device in cross sectional view.

FIG. 8 shows an embodiment of the present device in cross sectional view.

FIG. 9 shows an additional embodiment of the present invention in cross sectional view.

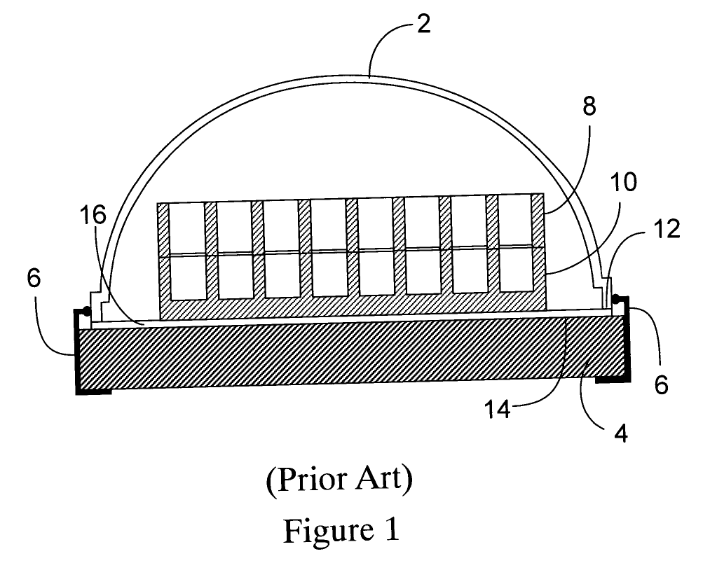

### DETAILED DESCRIPTION OF THE INVENTION

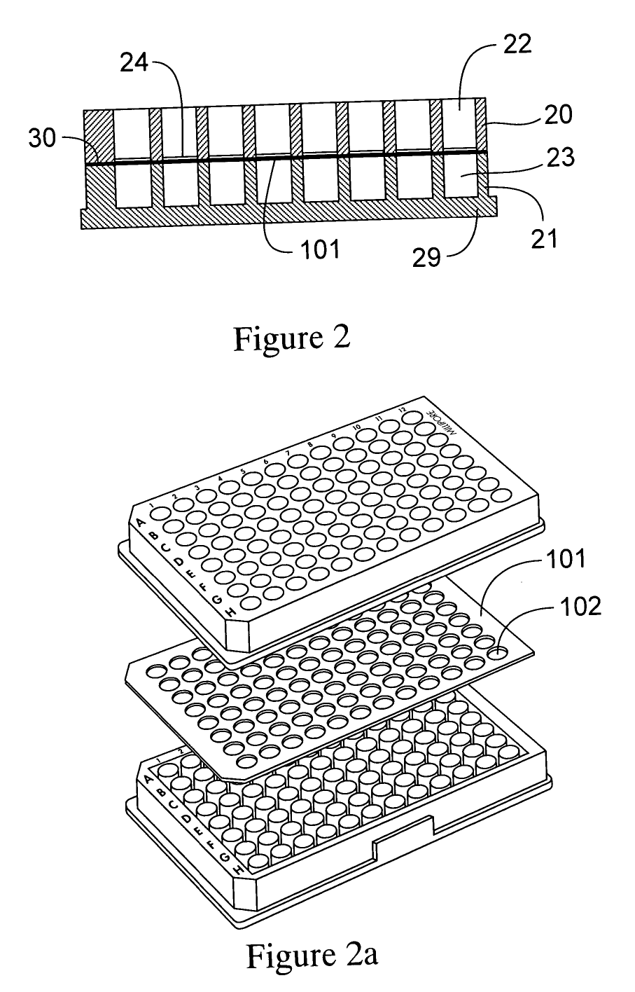

FIG. 2 shows a first embodiment of the present invention. A filter plate 20 is placed on top of a collection plate 21 such that the wells 22 of the filter plate 20 align with and are seated over the wells 23 of the collection plate 21. The bottom of the wells 22 of the filter plate 20 are open and sealed with a membrane or filter 24. The bottoms of the wells 23 of the collection plate 21 are closed and solid. An evaporation control device is shown as a sheet 101 interposed between the wells 22 of the filter plate 20 and the wells 23 of the collection plate 21. This material surrounds each well 22, 23 of the plates 20, 21 by having a series of holes 102, as shown in FIG. 2a, formed in the sheet 101 which are in register with and substantially the same diameter as the outside diameter of the wells 22, 23. The sheet 101 is preferably of a thickness from about 0.1 mm to about 15 mm and has a length and width substantially the same as that of the bottom surface of the filter plate 20 and the top surface of the collection plate 21. Preferably the holes 102 have a diameter that is slightly greater than that of the outer diameter of the wells 22, 23 so that the sheet 101 can be easily inserted between the plates. The sheet 101 reduces or eliminates the potential for evaporation of the filtrate as it passes from the filter plate 20 into the collection plate 21.

The sheet can be formed of any suitable plastic, rubber or elastomer. Suitable materials include but are not limited to plastics such as polyethylene, polypropylene, EVA copolymers, PVC, PTFE resin, acrylic and methacrylics, PET, PETG, KYNAR® PVDF resin and the like, rubbers including natural and synthetic rubbers, such as butyl or silicone rubber and elastomers such as EPDM polymers, thermoplastic elastomers such as SANTOPRENE® elastomers, urethanes, especially closed cell foam urethanes, VITON® elastomers and blends of the above.

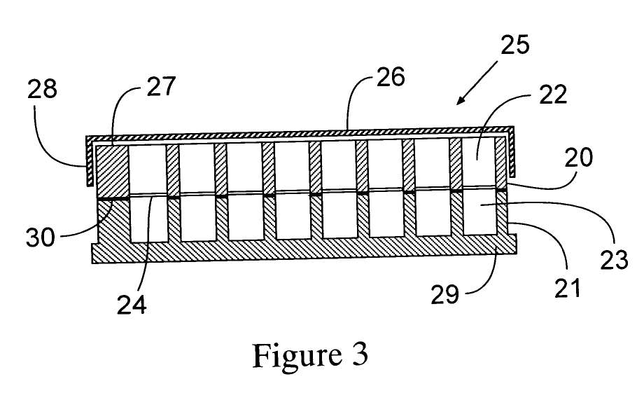

FIG. 3 shows a second embodiment of the present invention that incorporates all the elements of FIG. 2 and adds a cover 25. The cover 25 has a top surface 26 that preferably mates with the top surface 27 of the of the filter plate 20 and a skirt 28 that extends downwardly from the top surface 26 of the cover 25 on all sides (in this embodiment, the plates 20, 21 have four sides) of the plates 20, 21. As shown, the skirt extends downwardly from the top surface 27 of the filter plate 20 to a point below the top surface 27 of the filter plate 20.

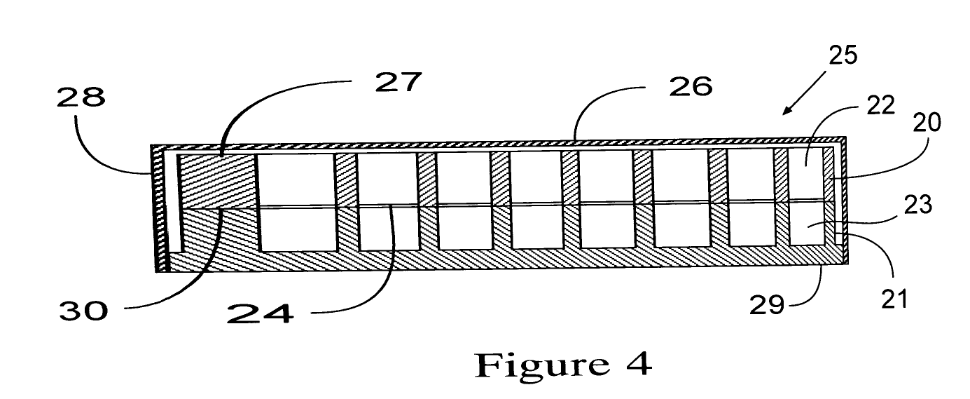

FIG. 4 shows an alternative embodiment of the present invention in cross sectional view. A filter plate 20 is placed on top of a collection plate 21 such that the wells 22 of the filter plate 20 align with and are seated over the wells 23 of the collection plate 21. The bottom of the wells 22 of the filter plate 20 are open and sealed with a membrane or filter 24. The bottoms of the wells 23 of the collection plate 21 are closed and solid. The evaporation control device in this embodiment is a cover 25 shown around the outside perimeter of the combined plates 20, 21. The cover 25 has a top surface 26 that preferably mates with the top surface 27 of the of the filter plate 20 and a skirt 28 that extends downwardly from the top surface 26 of the cover 25 on all sides (in this embodiment, the plates 20, 21 have four sides) of the plates 20, 21. As shown, the skirt extends downwardly from the top surface 27 of the filter plate 20 to a point at least below the thickness of the filtration plate or in other words, below an interface 30 of the two plates 20, 21. As shown, the preferred embodiment of the skirt 28 is shown in which the skirt 28 extends approximately down to the bottom surface 29 of the collection plate 21. The skirt 28 of the cover 25 acts in the same manner as the sheet 101 of FIGS. 2 and 2a and reduces evaporation at the interface between the two plates.

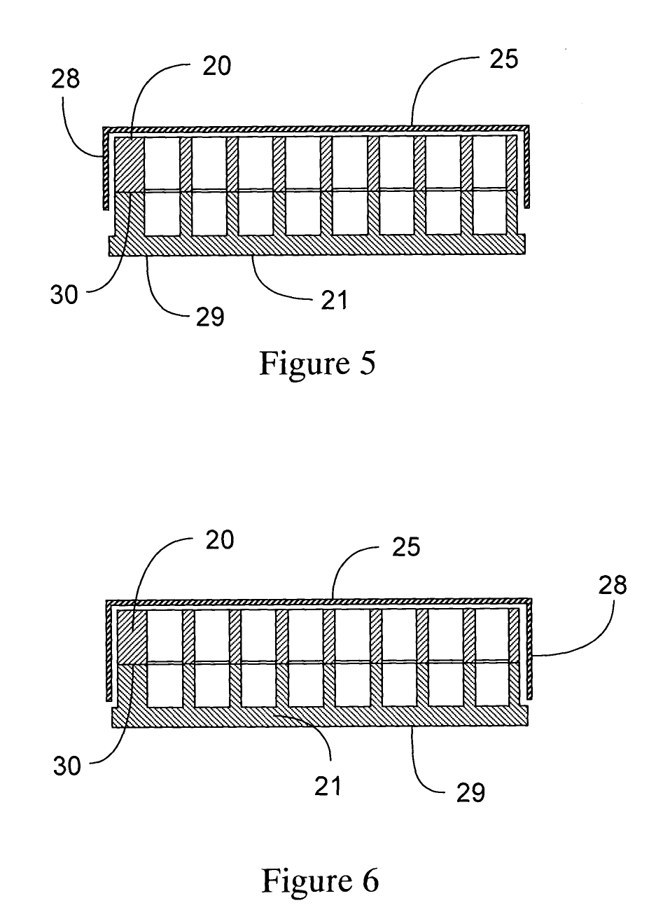

FIG. 5 shows an embodiment where the skirt 28 extends only slightly below the interface 30 formed between the filter plate 20 and the collection plate 21.

FIG. 6 shows an embodiment where the skirt 28 extends half way between the interface 30 formed between the filter plate 20 and the collection plate 21 and the bottom surface 29 of the collection plate 21.

Other skirt lengths may be used depending upon the design of the plates. It has been found by the inventors that the major locale for evaporation is the plate to plate interface where the membrane is located and that is why it is desirable to have the skirt extend at least a short way below the interface so as to minimize the amount of evaporation. In plates that might be designed to have a gasket formed between the interface, the skirt need not cover the interface, but it should still cover the top surface of the filter plate to minimize evaporation through the top of the filter plate and extend downward at least a short distance to ensure that it remains on during centrifugation without the need for clamps, elastic bands or adhesive strips.

As shown in FIGS. 3-6 the cover 25 also closely conforms to the outer dimensions of the plates so as to minimize the potential for evaporation and to prevent the cover from being removed during use by the air movement during centrifugation. A friction fit is not necessary but may be used in some instances. If one desires, one can design the plates and/or cover so that a friction fit only occurs at certain desired locations, such as adjacent the bottom surface of the collection plate so that the cover fits easily on and off the system when desired.

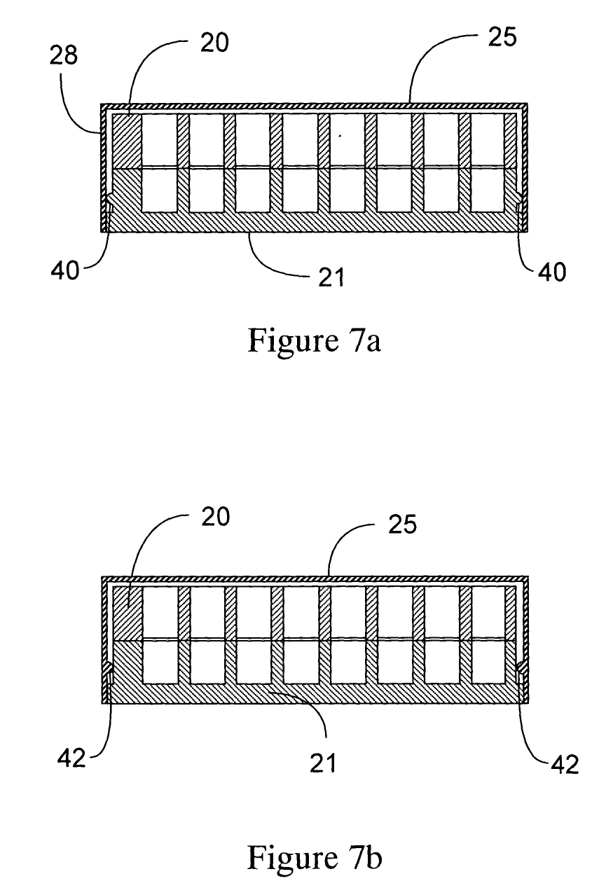

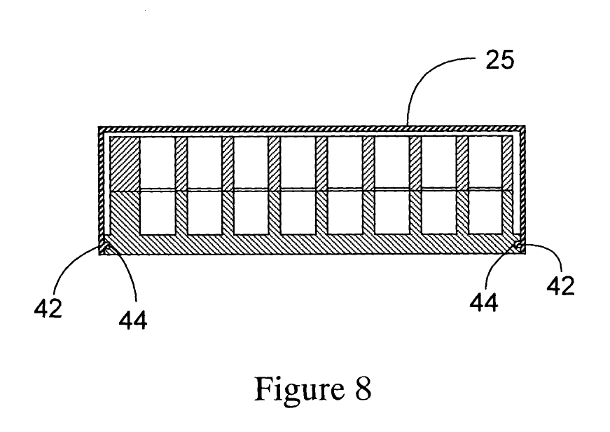

Alternatively, as shown in FIGS. 7a and 7b, the use of nubs 40 on at least the collection plate 21 and/or the inner surface 42 of the cover 25 may also be used to form a secure fit. Likewise, the use of nubs 40 and recesses 44 on the respective plate side walls and the inner surface of the cover as shown in FIG. 8 may also be used to create the desired retention feature.

The cover can be designed to fit various plate sidewall lengths. As most plates today are design to meet the proposed dimensional standards for the Society of Biomolecular Screening (SBS compliant), the overall length and width dimensions are relatively uniform and only the height of the sidewalls will vary between systems.

One embodiment is to design a cover for each specific plate combination.

Alternatively, one can make a cover having a set length that is typically the longest for the known combination of plates and make it of a thin plastic that can be trimmed to the desired height by the customer using a scalpel, razor or utility knife.

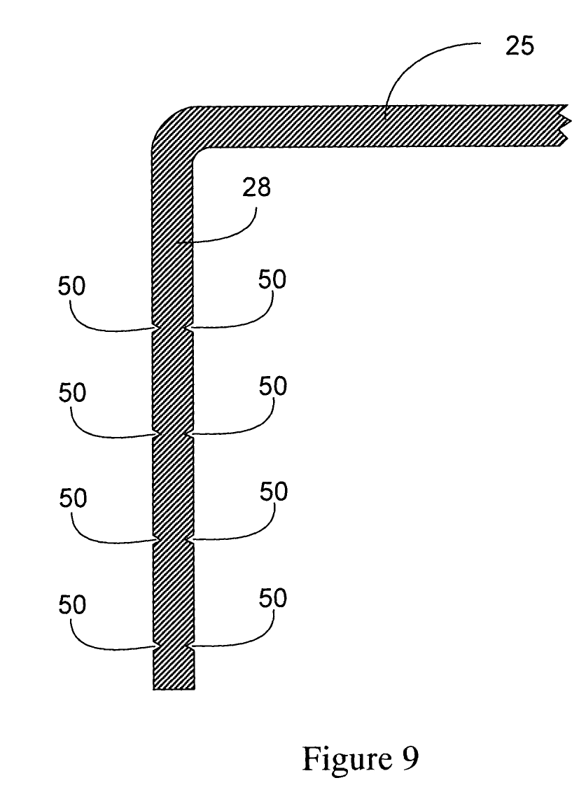

In another embodiment, one can make a cover having a set length that is typically the longest for the known combination of plates and form a series of one or more score lines in at least one surface of the cover sidewall so that the cover can be easily trimmed to an approximate height for use with a given plate system. FIG. 9 shows such a cover in a partial cross-sectional view with a series of score lines 50 formed in the skirt 28 of the cover 25.

The cover maybe formed of a cast or molded plastic, rubber or elastomer.

Alternatively, it may be formed by vacuum-forming, e.g. positioning a flat sheet of thin plastic that has been heated to a temperature at or near its softening point over a mold whose inside dimensions and configuration mimic that of the plate assembly and then applying a vacuum to it so as to draw it to the surface of the mold. Sheets of plastic ranging from 0.015 inch (0.038 mm) to 0.050 inch (0.127 mm) thick, preferably from 0.020 inch (0.0508 mm) to 0.030 inch (0.0762 mm) thick, can be used. The plastic may be clear, opaque or of a solid color. These sheets were heated to approximately 275° F. (527° C.) and formed into place at 25 to 30 in-Hg of vacuum.

For the vacuum-formed cover, suitable plastics include but are not limited to PET, PETG, polystyrenes; polycarbonates; polyolefin homopolymers, copolymers and blends, such as polyethylene, polypropylene and the like; acrylic and methacrylics, vinyls, polysulfones, polyarlysulfones and polyethersulfones.

The plates may be formed of 2 or more wells, typically they contain 12, 24, 96, 384 or 1536 wells arranged in even and a parallel rows and columns. The plates may be made of polymeric, especially thermoplastic materials, glass, metallic materials, ceramic materials, elastomeric materials, coated cellulosic materials and combinations thereof such as epoxy impregnated glass mats. In a more preferable embodiment, the plate is formed of a polymeric material including but not limited to polyethylene, acrylic, polycarbonate and styrene. The wells can be made by injection molding, drilling, punching and any other method well known for forming holes in the material of selection. Such plates are well known and commercially available from a variety of sources in a variety of well numbers and designs such as MultiScreen® multiwell plates and the Ultracel™ filtration plate available from Millipore Corporation off Bedford, Mass.

The filter plates contain a filter in or across the bottom of the well of the top plate to form a semi-permeable surface (i.e. when no force is applied, the fluid doesn't pass through the filter. When force is applied to the filter via centrifugation, fluid is able to pass through the filter) through which all fluid in the well must pass in order to exit into the collection plate below it.

Ultrafiltration (UF) filters, which may be used in this process, can be formed from the group including but not limited to polysulfones, including polysulfone, polyethersulfone, polyphenylsulfones and polyarylsulfones, polyvinylidene fluoride, and cellulose and its derivatives, such as nitrocellulose and regenerated cellulose. These filters typically include a support layer that is generally formed of a highly porous structure. Typical materials for these support layers include various non-woven materials such as spun bounded polyethylene or polypropylene, paper or glass or microporous materials formed of the same or different polymer as the filter itself. Alternatively, the support may be an openly porous, asymmetric integral portion of the ultrafiltration filter that may either be formed with or without macrovoids. Such filters are well known in the art, and are commercially available from a variety of sources such as Millipore Corporation of Bedford, Mass.

Preferred UF filters include regenerated cellulose or polysulfone filters such as YM™ or Biomax™ filters available from Millipore Corporation of Bedford, Mass.

Representative suitable microporous filters include nitrocellulose, cellulose acetate, regenerated cellulose, polysulphones including polyethersulphone and polyarylsulphones, polyvinylidene fluoride, polyolefins such as ultrahigh molecular weight polyethylene, low density polyethylene and polypropylene, nylon and other polyamides, PTFE, thermoplastic fluorinated polymers such as poly (TFE-co-PFAVE), polycarbonates or particle filled filters such as EMPORE® filters available from 3M of Minneapolis, Minn. Such filters are well known in the art and available from a variety of sources, such as DURAPORE® filters and EXPRESS® filters available from Millipore Corporation of Bedford, Mass.

### EXAMPLE 1

A plate assembly comprised of a MultiScreen® filtration plate containing an Ultracel™—PPB membrane, available from Millipore Corporation of Bedford, Mass., containing 96 wells each with a UF membrane (PLGCPB NMWCO=10,000 Daltons) sealed to the bottom inside of each well was placed on top of a collection plate (Greiner, Polypropylene V bottom # 651201, available from Millipore Corporation of Bedford, Mass.) and the extended centrifugal cover also available from Millipore Corporation.

Three sets of these systems were set up for each material tested, one with no cover (Control A), one used under a dome, Clear Sealed μT Catalog Number 11178216 available from Jouan of Winchester, Va. (Control B) and the last with the cover of the present invention (Invention).

The materials tested included: 4% BSA (Bovine Serum Albumin) solution, and ABS (Adult Bovine Serum).

Each filter well was filled with 300 μl of a given solution.

The plates were loaded on to a Jouan CR412 swinging bucket centrifuge available from Jouan of Winchester, Va. and rotated at 3000×g force for 30 minutes at a temperature for 37° C.

The plates were then removed and the amount of filtrate in each well was determined and recorded.

The results (which are calculated from the difference in mass having gone through the filter plate and the mass measured in the receiver plate) are shown in Table 1 below:

TABLE 1

| | | Solution Mass | Mass Loss |
|---|---|---|---|
| Plate | Material | Filtered (grams) | (grams) |
| Control A | BSA | 8.4 | 3.8 |
| Control B | BSA | 6.6 | 0.2 |
| Invention | BSA | — | — |
| Control A | ABS | — | — |
| Control B | ABS | 6.11 | 0.09 |
| Invention | ABS | 5.73 | 0.26 |

### EXAMPLE 2

The length of the side skirt of device according to the present invention was tested in the following manner:

A=a side skirt extending the full height of the side of the plate assembly

B=a side skirt extending three fourths the height of the side of the plate assembly

C=a side skirt extending the height of the side of the plate assembly to the top of the receiver plate skirt (approximately 90% of the height covered).

These covers were used on the plate system described as in Example 1 and each well of each filter plate was filled with 300 μl amount of 100% ABS and subjected to the same centrifugation regiment as described in Example 1. The amount of filtrate was measured and recorded. The results are shown in Table 2.

TABLE 2

| | Solution Mass Filtered | Mass Loss |
|---|---|---|
| Plate | (Grams) | (Grams) |
| A | 5.73 | 0.26 |
| B | 5.98 | 0.51 |
| C | 5.90 | 0.34 |

What is claimed:

1) A system for reducing evaporation in a multiwell filtration plate comprising a filtration plate having a top and bottom surface and a thickness between, a collection plate having a top and bottom surface and a thickness between, the filtration plate containing a series of wells running through the thickness of the plate and having a filter sealed to the bottom of each well so that any fluid exiting the well through the lower surface must pass through the filter, the collection plate containing a series of wells formed through a portion of the thickness of the plate from its top surface, the filtration plate being placed on top of the collection plate so that the wells of the plates are in register with each other and form a continuous path between a well of the filtration plate and the corresponding well of the collection plate and an evaporation control device that is formed between the bottom surface of the filtration and the top surface of the collection plate.

2) The system of claim 1 wherein the evaporation control device is a sheet material interposed between the bottom surface of the filtration plate and the top surface of the collection plate, the sheet having a top surface, a bottom surface and a thickness between, the sheet containing a series of holes equal in number and spacing with the wells of the filtration plate and collection plate so as to be in register with both.

3) The system of claim 1 wherein the evaporation control device is a sheet material interposed between the bottom surface of the filtration plate and the top surface of the collection plate, the sheet having a top surface, a bottom surface and a thickness between, the sheet containing a series of holes equal in number and spacing with the wells of the filtration plate and collection plate so as to be in register with both and the sheet being formed of a material selected from the group consisting of plastic, rubber and elastomers.

4) The system of claim 1 wherein the evaporation control device is a sheet material interposed between the bottom surface of the filtration plate and the top surface of the collection plate, the sheet having a top surface, a bottom surface and a thickness between, the sheet containing a series of holes equal in number and spacing with the wells of the filtration plate and collection plate so as to be in register with both plates and the holes being slightly larger in diameter than the wells of the plates.

5) The system of claim 1 wherein the evaporation control device is a cover formed of a top surface and a skirt that extends downwardly from the top surface of the cover on all sides of the plate assembly to a point below the thickness of the filtration plate and at least a portion of the thickness of the collection plate.

6) The system of claim 1 wherein the evaporation control device is a cover formed of a top surface and a skirt that extends downwardly the entire combined thickness of the two plates.

7) The cover system of claim 1 wherein the evaporation control device is a cover formed of a top surface and a skirt that extends downwardly three quarters (75%) of the entire combined thickness of the two plates.

8) The cover system of claim 1 wherein the evaporation control device is a cover formed of a top surface and a skirt that extends downwardly two thirds (66.67%) of the entire combined thickness of the two plates.

9) The cover system of claim 1 wherein the evaporation control device is a cover formed of a top surface and a skirt that extends downwardly the entire combined thickness of the two plates and the top surface of the cover mates with the top surface of the of the filter plate.

10) The cover system of claim 1 wherein the evaporation control device is a cover formed of a top surface and a skirt that extends downwardly from the top surface of the cover on all sides of the plate assembly to a point below the thickness of the filtration plate and at least a portion of the thickness of the collection plate and the cover is formed of a vacuum-formed plastic.

11) The cover system of claim 1 wherein the evaporation control device is a cover formed of a top surface and a skirt that extends downwardly from the top surface of the cover on all sides of the plate assembly to a point below the thickness of the filtration plate and at least a portion of the thickness of the collection plate and the cover is formed of a molded plastic.

12) The cover system of claim 1 wherein the evaporation control device is a cover formed of a top surface and a skirt that extends downwardly from the top surface of the cover on all sides of the plate assembly to a point below the thickness of the filtration plate and at least a portion of the thickness of the collection plate and the skirt extends the entire combined thickness of the two plates and contains a series of two or more score lines spaced apart from each other by a set vertical distance so as to allow the skirt to be trimmed to a shorter length.

13) The cover system of claim 1 wherein the evaporation control device is a cover formed of a top surface and a skirt that extends downwardly from the top surface of the cover on all sides of the plate assembly and skirt extends the entire combined thickness of the two plates and the skirt contains a series of two or more score lines evenly spaced apart from each other by a set vertical distance so as to allow the skirt to be trimmed to a shorter length.

14) An evaporation control system for a multiwell filtration plate comprising a filtration plate having a top and bottom surface and a thickness between, a collection plate having a top and bottom surface and a thickness between, the filtration plate containing a series of wells running through the thickness of the plate and having a filter sealed to the bottom of each well so that any fluid exiting the well through the lower surface must pass through the filter, the collection plate containing a series of wells formed through a portion of the thickness of the plate from its top surface, the filtration plate being placed on top of the collection plate so that the wells of the plates are in register with each other and form a continuous path between a well of the filtration plate and the corresponding well of the collection plate, an interface being formed between the filtration plate and the collection plate where their bottom and top surfaces respectively mate and a cover formed of a top surface and a skirt that extends downwardly from the top surface of the cover on all sides of the to a point below the interface.

15) The cover system of claim 14 wherein the skirt extends the entire combined thickness of the two plates.

16) The cover system of claim 14 wherein the skirt extends to a point half (50%) the thickness of the collection plate.

17) The cover system of claim 14 wherein the skirt extends to a point two thirds (66.67%) the thickness of the collection plate.

18) The cover system of claim 14 wherein the skirt extends to a point three quarters (75%) the thickness of the collection plate.

19) An evaporation control system for a multiwell filtration plate comprising a filtration plate having a top and bottom surface and a thickness between, a collection plate having a top and bottom surface and a thickness between, the filtration plate containing a series of wells running through the thickness of the plate and having a filter sealed to the bottom of each well so that any fluid exiting the well through the lower surface must pass through the filter, the collection plate containing a series of wells formed through a portion of the thickness of the plate from its top surface, the filtration plate being placed on top of the collection plate so that the wells of the plates are in register with each other and form a continuous path between a well of the filtration plate and the corresponding well of the collection plate, an interface being formed between the filtration plate and the collection plate where their bottom and top surfaces respectively mate, a first evaporation control device being formed of a sheet material interposed between the bottom surface of the filtration plate and the top surface of the collection plate, the sheet having a top surface, a bottom surface and a thickness between, the sheet containing a series of holes equal in number and spacing with the wells of the filtration plate and collection plate so as to be in register with both and a second evaporation control device being formed as a cover formed of a top surface and a skirt that extends downwardly from the top surface of the cover on all sides of the to a point below the interface of the two plates.
